(19) United States
(12) Patent Application Publication
(10) Pub. No.: US 2026/0137971 A1
(43) Pub. Date: May 21, 2026

(54) FIRE EXTINGUISHING SYSTEM FOR A VEHICLE

(71) Applicants: HYUNDAI MOTOR COMPANY, Seoul (KR); KIA CORPORATION, Seoul (KR)

(72) Inventor: Wook Hwan Jeong, Hwaseong-si (KR)

(73) Assignees: HYUNDAI MOTOR COMPANY, Seoul (KR); KIA CORPORATION, Seoul (KR)

(21) Appl. No.: 19/188,624

(22) Filed: Apr. 24, 2025

(30) Foreign Application Priority Data
Nov. 19, 2024 (KR) 10-2024-0164656

(51) Int. Cl. A62C 37/40; A62C 3/07; A62C 3/16

(52) U.S. Cl. CPC A62C 37/40; A62C 3/07; A62C 3/16

(57) ABSTRACT

A fire extinguishing system for a vehicle includes a suction-discharge pipe provided in each fire response space and provided with a nozzle for spraying a fire extinguishing fluid, a smoke detection pipe connected to the suction-discharge pipe through a control valve, an air compressor that applies suction pressure to the smoke detection pipe, a smoke detector that detects smoke suctioned through the nozzle and the suction-discharge pipe by the suction pressure of the air compressor, a controller that outputs, in a case where the smoke is detected by the smoke detector in a fire detection mode in each fire response space, a control signal for spraying the fire extinguishing fluid to the fire response space where the smoke is detected, and a fire extinguishing fluid supply device that supplies the fire extinguishing fluid to the suction-discharge pipe in the fire response space where the smoke is detected.

### CROSS-REFERENCE TO RELATED APPLICATION

This application claims, under 35 U.S.C. § 119(a), the benefit of and priority to Korean Patent Application No. 10-2024-0164656 filed on Nov. 19, 2024, the entire contents of which are incorporated herein by reference.

### BACKGROUND

### (a) Technical Field

The present disclosure relates to a fire extinguishing system for a vehicle capable of detecting fire occurring in the vehicle and extinguishing the fire.

### (b) Background

In general, vehicles use flammable fuel, have multiple heat sources, and have various electrical wires tangled together, so there is a constant risk of fire.

For example, since a high-temperature engine and various electrical devices are provided in an engine compartment of a vehicle, the engine and electrical devices may be damaged or malfunction due to a collision accident or the like thereby resulting in fire. Further, in the engine compartment, there is a risk of fire during vehicle driving due to engine overheating or exhaust gas post-treatment.

In order to prepare for such a risk, use of a fire extinguisher is generally considered. However, in a case where a driver fails to use the fire extinguisher in time, it is difficult to extinguish the fire, so that the fire may spread throughout the vehicle.

Moreover, in the case of a public transportation vehicle such as a bus in which many passengers ride, fire prevention management is essential for passenger safety because fire occurring in such a public transportation vehicle may lead to a large-scale disaster.

In addition, since the driver is inside the vehicle during driving, even in a case where fire occurs in the engine compartment, the fire may not be noticed until a large amount of smoke is generated. For example, when an engine compartment of a bus is located at the rear of the vehicle, it is more difficult for the driver to notice the engine compartment fire.

Therefore, in a case where the driver fails to quickly take action to extinguish the fire in an early stage, the fire may spread and the entire vehicle may burn, which may increase the risk of casualties. Even in a case where the driver or passengers inside the vehicle are aware of the fire, it is difficult to extinguish the fire using only the small fire extinguisher provided in the vehicle.

Recently, as the use of eco-friendly vehicles such as electric vehicles and fuel cell vehicles increases, the risk of fire in batteries or high-voltage electrical wires due to external impact or internal short circuit is increasing.

In particular, in the case of a large electric bus (xEV), a PE (Power Electric) compartment where various electric devices and electrical wires are provided is located at the rear of the vehicle instead of an engine compartment. FIG. 1 is a diagram briefly showing a PE compartment 2 of a vehicle 1 such as an electric bus.

In the PE compartment 2, automotive electronics (PE components) and electrical wires are provided in a complex manner. Although not shown in detail in the drawing, a motor for driving a vehicle, an LDC (Low voltage DC-DC Converter) that is a power conversion system, low voltage/high voltage wires, a water heater, a junction box, an air compressor, a cooling module, and the like are provided therein.

As a result of analysis of a fire occurrence probability in the devices or components provided in the PE compartment 2, the fire occurrence probability was the highest in the low-voltage/high-voltage wires.

As a result of a fire simulation test conducted by increasing electric current by 100A using the low-voltage/high-voltage wires, smoke was generated at a part where a connector and a cable were in contact, and it was found that a gas (smoke) detector was suitable as a fire detection sensor in the PE compartment 2.

Using a flame detector as a fire detection sensor is the most accurate method, but the flame detector cannot detect fire in its early stage, and can detect the fire only when the fire spreads to a certain extent.

Since a temperature detector can only detect a rise in temperature at its installation location, it is not possible to cover the entire space of the PE compartment for fire detection with a small number of temperature detectors, and in a case where a large number of temperature detectors is provided in the PE compartment, the layout becomes very complicated.

A smoke detector may be used as a fire detection sensor in the PE compartment 2 of the electric bus, but the biggest problem when using the gas (smoke) detector is the presence of a cooling fan (electric fan). In a case where fire occurs while the cooling fan is in operation, smoke may not move to the smoke detector due to the cooling fan.

Among devices that make up a cooling module, the cooling fan is a device that supplies air to a radiator. The cooling fan is generally provided on a rear side of the vehicle 1 as shown in FIG. 1, and suctions in outside air and supplies the same to the PE compartment 2.

Forced convection of air occurs inside the PE compartment 2 by the air supplied by the cooling fan, and as the air moves strongly in one direction, the smoke generated here also moves.

In this case, the smoke detector should be able to detect the fire by detecting smoke when fire breaks out. However, in a case where fire occurs at the time when the cooling fan is operating, the smoke is more likely to not reach the smoke detector due to the air blown by the cooling fan, and thus, the fire may not be detected by the smoke detector.

The above information disclosed in this Background section is only for enhancement of understanding of the background of the disclosure and therefore it may contain information that does not form the prior art that is already known to those having ordinary skill in the art.

### SUMMARY OF THE DISCLOSURE

The present disclosure has been made in an effort to solve the-described problems associated with prior art, and an object of the present disclosure is to provide a fire extinguishing system for a vehicle capable of accurately detecting fire occurring in the vehicle and quickly and automatically extinguishing the fire.

In one aspect, a fire extinguishing system for a vehicle includes: a smoke suctioning and fire extinguishing fluid discharge pipe provided in each of a plurality of fire response spaces and provided with a nozzle for spraying a fire extinguishing fluid; a smoke detection pipe connected to the smoke suctioning and fire extinguishing fluid discharge pipe through a control valve to selectively communicate with the smoke suctioning and fire extinguishing fluid discharge pipe; an air compressor configured to apply suction pressure to the smoke detection pipe; a smoke detector configured to detect smoke suctioned through the nozzle and the smoke suctioning and fire extinguishing fluid discharge pipe by the suction pressure of the air compressor acting on the smoke suctioning and fire extinguishing fluid discharge pipe through the smoke detection pipe; a controller configured to output, based on the smoke detected by the smoke detector after entering a fire detection mode in a fire response space selected from the plurality of fire response spaces, a control signal for spraying the fire extinguishing fluid to the fire response space where the smoke is detected; and a fire extinguishing fluid supply device configured to supply, according to or based on the control signal output from the controller, the fire extinguishing fluid to the smoke suctioning and fire extinguishing fluid discharge pipe in the fire response space where the smoke is detected through a fire extinguishing fluid supply pipe.

In an embodiment, the plurality of fire response spaces may include at least one of a power electric (PE) compartment in which power electric (PE) parts are provided or a battery compartment in which a battery is provided.

In another embodiment, the control valve may be configured to control a flowing direction of the fire extinguishing fluid in the fire extinguishing fluid supply pipe so that the fire extinguishing fluid supplied from the fire extinguishing fluid supply device according to or based on the control signal output by the controller is supplied to the fire response space where the smoke is detected.

In still another embodiment, the fire extinguishing fluid supply pipe extended from the fire extinguishing fluid supply device may be branched to each of the plurality of fire response spaces and connected to the smoke suctioning and fire extinguishing fluid discharge pipe in each of the plurality of fire response spaces, the control valve may be provided at a location where the fire extinguishing fluid supply pipe is branched, the smoke detection pipe may be connected to the control valve, and the smoke detection pipe may be configured to selectively communicate with the smoke suctioning and fire extinguishing fluid discharge pipe in each of the plurality of fire response spaces through the fire extinguishing fluid supply pipe branched to each of the plurality of fire response spaces according to or based on an opening state of the control valve.

In yet another embodiment, the controller may be further configured to operate the air compressor in the fire detection mode, and may control the opening state of the control valve so that the fire extinguishing fluid supply pipe branched to the fire response space in the fire detection mode and the smoke detection pipe communicate with each other to apply suction pressure by the air compressor to the fire response space in the fire detection mode.

In still yet another embodiment, the plurality of fire response spaces may include a power electric (PE) compartment in which power electric (PE) parts are provided, and a battery compartment in which a battery is provided. Further, the control valve may be a 4-way valve provided between the fire extinguishing fluid supply pipe connected to the fire extinguishing fluid supply device, the fire extinguishing fluid supply pipe branched to the PE compartment, the fire extinguishing fluid supply pipe branched to the battery compartment, and the smoke detection pipe.

In a further embodiment, the system may further include a temperature sensor provided in each of the power electric fire response spaces, and the controller may be further configured to determine whether a smoke detection condition of each of the plurality of fire response spaces is satisfied based on a temperature detected by the temperature sensor, and execute the fire detection mode in the fire response space in which the smoke detection condition is determined to be satisfied.

In another further embodiment, a plurality of temperature sensors may be provided in each of the plurality of fire response spaces, and the controller may be further configured to determine, in a case where or based on that a maximum value of change values of temperatures detected by the plurality of temperature sensors provided in each of the plurality of fire response spaces for a preset time is equal to or greater than a predetermined change value, or a maximum value of the temperatures detected by the plurality of temperature sensors is equal to or greater than a predetermined temperature, that a fire detection condition in a corresponding fire response space is satisfied, and execute the fire detection mode for the corresponding fire response space.

In still another further embodiment, the plurality of fire response spaces may include a power electric (PE) compartment in which PE parts are provided, and a battery compartment in which a battery is provided. Further, the controller may be configured to execute the fire detection mode for the battery compartment, based on a determination that the smoke detection conditions of the PE compartment and the battery compartment are simultaneously satisfied and the temperatures detected by the temperature sensor provided in the PE compartment and the temperature sensor provided in the battery compartment.

In yet another further embodiment, the controller may be further configured to execute the fire detection mode for the PE compartment, in a case where or based on that the smoke detection conditions of the PE compartment and the battery compartment are simultaneously satisfied, and smoke in the battery compartment is not detected for a predetermined time by the smoke detector in the fire detection mode for the battery compartment.

In still yet another further embodiment, the controller may be further configured to operate the air compressor in the fire detection mode, and control an opening state of the control valve so that the smoke suctioning and fire extinguishing fluid discharge pipe provided in the fire response space in which the smoke detection condition is satisfied and the smoke detection pipe communicate with each other to apply suction pressure by the air compressor to the fire response space in which the smoke detection condition is satisfied.

In a still further embodiment, in applying the suction pressure of the air compressor to the smoke suctioning and fire extinguishing fluid discharge pipe provided in the fire response space through the smoke detection pipe, the controller may be further configured to determine a target speed from or based on a speed of a cooling fan provided in the fire response space, and control an operation of the air compressor at the determined target speed.

In a yet still further embodiment, the speed of the air compressor may be determined as a higher value as the speed of the cooling fan provided in the fire response space is higher. In other words, the speed of the air compressor increases as the speed of the cooling fan installed in the fire response space increases.

In yet another further embodiment, the fire extinguishing fluid supply device may include a fire extinguishing fluid tank in which the fire extinguishing fluid is stored, and a pressure transfer plate configured to be moved by pressure of a working fluid supplied to a pressure chamber of the fire extinguishing fluid tank and pressurize the fire extinguishing fluid charged in the fire extinguishing fluid chamber of the fire extinguishing fluid tank to discharge the fire extinguishing fluid from the fire extinguishing fluid tank to the fire extinguishing fluid supply pipe.

In still yet another further embodiment, the working fluid may be compressed air supplied by the air compressor.

In one aspect, a fire extinguishing system for a vehicle includes: a smoke suctioning and fire extinguishing fluid discharge pipe provided in each of a plurality of fire response spaces and provided with a nozzle for spraying a fire extinguishing fluid; a smoke detection pipe connected to the smoke suctioning and fire extinguishing fluid discharge pipe through a control valve to selectively communicate with the smoke suctioning and fire extinguishing fluid discharge pipe; an air compressor configured to apply suction pressure to the smoke detection pipe; a smoke detector configured to detect smoke suctioned through the nozzle and the smoke suctioning and fire extinguishing fluid discharge pipe by the suction pressure of the air compressor acting on the smoke suctioning and fire extinguishing fluid discharge pipe through the smoke detection pipe; and a controller. The controller is configured to: receive an electrical signal from a smoke detector configured to detect smoke suctioned through the nozzle and the smoke suctioning and fire extinguishing fluid discharge pipe by the suction pressure of the air compressor acting on the smoke suctioning and fire extinguishing fluid discharge pipe through the smoke detection pipe; output, based on the smoke detected by the smoke detector after entering a fire detection mode in a fire response space selected from the plurality of fire response spaces, a control signal for spraying the fire extinguishing fluid to the fire response space where the smoke is detected; and cause a fire extinguishing fluid supply device to supply the fire extinguishing fluid to the smoke suctioning and fire extinguishing fluid discharge pipe in the fire response space where the smoke is detected through a fire extinguishing fluid supply pipe.

The plurality of fire response spaces may include at least one of a power electric (PE) compartment in which PE parts are provided or a battery compartment in which a battery is provided.

the control valve may be configured to control a flowing direction of the fire extinguishing fluid in the fire extinguishing fluid supply pipe so that the fire extinguishing fluid supplied from the fire extinguishing fluid supply device based on the control signal output by the controller is supplied to the fire response space where the smoke is detected.

The fire extinguishing fluid supply pipe extended from the fire extinguishing fluid supply device may be branched to each of the plurality of fire response spaces and connected to the smoke suctioning and fire extinguishing fluid discharge pipe in each of the plurality of fire response spaces. The control valve may be provided at a location where the fire extinguishing fluid supply pipe is branched. The smoke detection pipe may be connected to the control valve. The smoke detection pipe may be configured to selectively communicate with the smoke suctioning and fire extinguishing fluid discharge pipe in each of the plurality of fire response spaces through the fire extinguishing fluid supply pipe branched to each of the plurality of fire response spaces based on an opening state of the control valve.

The controller may be further configured to: operate the air compressor in the fire detection mode; and control the opening state of the control valve so that the fire extinguishing fluid supply pipe branched to the fire response space in the fire detection mode and the smoke detection pipe communicate with each other to apply suction pressure by the air compressor to the fire response space in the fire detection mode.

Other aspects and embodiments of the disclosure are discussed below.

### BRIEF DESCRIPTION OF THE DRAWINGS

The and other features of the present disclosure are described in detail with reference to certain embodiments thereof illustrated the accompanying drawings which are given hereinbelow by way of illustration only, and thus are not limitative of the present disclosure, and wherein:

FIG. 1 is a diagram illustrating occurrence of forced convection of air inside a PE compartment by a cooling fan in a typical electric bus;

FIG. 2 is a block diagram showing a configuration of a fire extinguishing system according to an embodiment of the present disclosure;

FIG. 3 is a diagram showing a state in which a smoke suctioning and fire extinguishing fluid discharge pipe of a fire extinguishing system according to an embodiment of the present disclosure is provided in a PE compartment;

FIG. 4 is a diagram showing a state in which a smoke suctioning and fire extinguishing fluid discharge pipe of a fire extinguishing system according to an embodiment of the present disclosure is provided in a battery compartment;

FIG. 5 is a diagram showing a configuration of a fire extinguishing system according to an embodiment of the present disclosure;

FIG. 6 is a diagram showing a photoelectric smoke detector having a light-emitting element and a light-receiving element according to an embodiment of the present disclosure;

FIG. 7 is a diagram showing a configuration of a nozzle provided in a smoke suctioning and fire extinguishing fluid discharge pipe according to an embodiment of the present disclosure;

FIG. 8 is a diagram showing an operating state of the nozzle in a fire detection mode according to an embodiment of the present disclosure;

FIG. 9 is a diagram showing an operating state of the nozzle when spraying a fire extinguishing fluid according to an embodiment of the present disclosure;

FIG. 10 is a diagram showing an operating state in a PE compartment fire detection mode of the fire extinguishing system according to an embodiment of the present disclosure;

FIG. 11 is a diagram showing an operating state in a battery compartment fire detection mode of the fire extinguishing system according to an embodiment of the present disclosure;

FIG. 12 is a diagram showing an operating state in the PE compartment fire extinguishing mode of the fire extinguishing system according to an embodiment of the present disclosure;

FIG. 13 is a diagram showing an operating state in the battery compartment fire extinguishing mode of the fire extinguishing system according to an embodiment of the present disclosure;

FIG. 14 is a diagram illustrating a method of determining whether to enter a fire detection mode by a controller of a fire extinguishing system according to an embodiment of the present disclosure;

FIG. 15 is a diagram illustrating a control state of a control valve and an exhaust valve by the controller of the fire extinguishing system according to an embodiment of the present disclosure;

FIG. 16 is a diagram illustrating a method for determining a speed of an air compressor by the controller of the fire extinguishing system according to an embodiment of the present disclosure;

FIG. 17 is a diagram illustrating a method for detecting fire by the controller of the fire extinguishing system according to an embodiment of the present disclosure; and

FIG. 18 is a diagram illustrating a control state in fire detection of the fire extinguishing system according to an embodiment of the present disclosure.

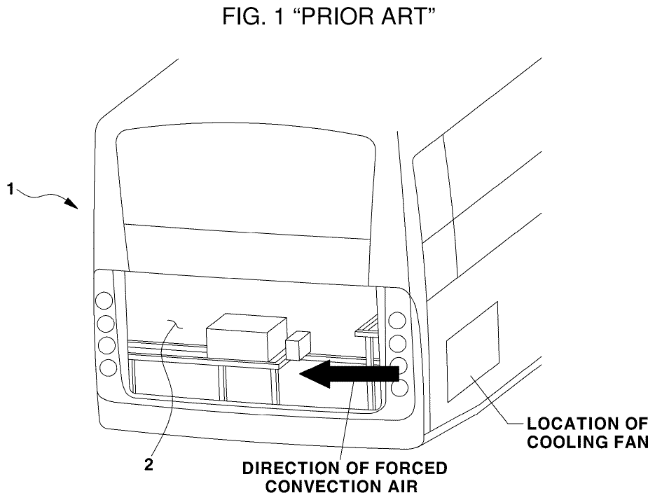

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, embodiments of the present disclosure are described in detail with reference to the accompanying drawings. Specific structural or functional descriptions presented in embodiments of the present disclosure are merely exemplified for the purpose of describing embodiments according to the concept of the present disclosure, and embodiments according to the concept of the present disclosure may be implemented in various forms. Furthermore, the present disclosure should not be construed as limited to embodiments described in this specification, but should be understood to include all modifications, equivalents, or substitutes included in the concept and technical scope of the present disclosure.

It should be understood that, although the terms “first”, “second”, and the like may be used herein to describe various elements, these elements should not be limited by these terms. These terms are only used to distinguish one element from another. For example, a first element may be termed a second element, and, similarly, a second element may be termed a first element, without departing from the scope of embodiments of the present disclosure.

In addition, it should be understood that, when an element is “connected” or “coupled” to another element, it may be directly connected or coupled to the other element, or may be indirectly connected or coupled to the other element with a different element being interposed therebetween. In contrast, when an element is “directly connected” or “directly coupled” to another element, this means that there is no intervening element therebetween. Other expressions used to describe the relationship between elements should be interpreted in a similar manner (for example, “between” and “directly between”, “adjacent” and “directly adjacent”, and the like).

Wherever possible, the same reference numbers are used throughout the drawings to refer to the same or like parts. The terminology used herein is for the purpose of describing particular embodiments only and is not intended to limit embodiments of the disclosure. As used herein, the singular forms “a”, “an”, and “the” are intended to include the plural forms as well, unless the context clearly indicates otherwise. It should be further understood that the terms “comprise”, “include”, and “have” used herein specify the presence of stated components, steps, operations, and/or elements, but do not preclude the presence or addition of one or more other components, steps, operations, and/or elements.

When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, apparatus, and the like may separately embody or be included with a processor and a memory, such as a non-transitory computer readable media, as part of the apparatus.

In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

The present disclosure relates to a fire extinguishing system for a vehicle, capable of accurately detecting fire occurring in the vehicle and quickly and automatically extinguishing the fire. The vehicle may be a large vehicle, for example, a bus.

More specifically, the vehicle may be a vehicle driven by a motor powered by a battery, for example, an electric vehicle (xEV) such as a hydrogen electric bus (fuel cell bus) or a battery electric bus.

A fire extinguishing system according to an embodiment of the present disclosure may be a fire extinguishing system capable of detecting and extinguishing fire occurring in a PE compartment located at the rear of a vehicle, or may be a fire extinguishing system capable of detecting and extinguishing fire occurring in a battery compartment, for example, a battery compartment provided on an upper side of a vehicle roof.

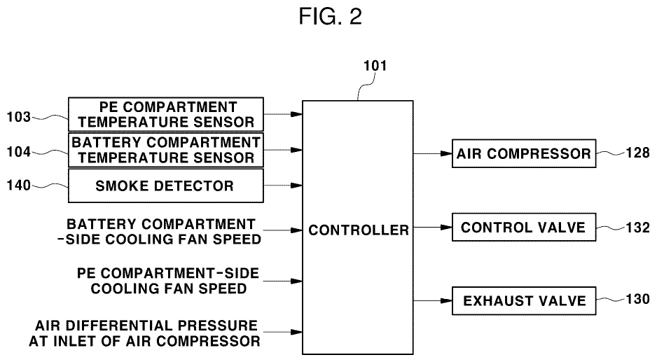

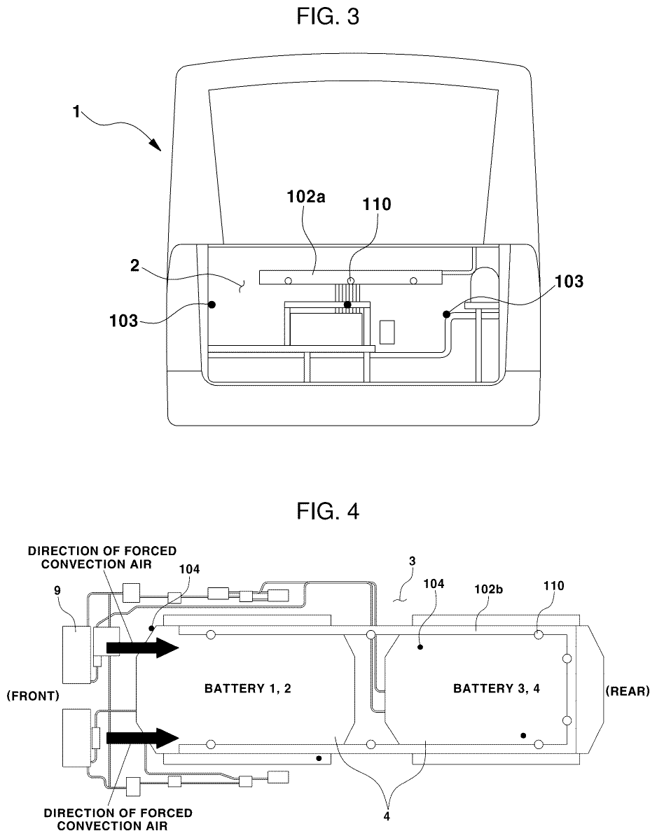

FIG. 2 is a block diagram showing a configuration of a fire extinguishing system according to an embodiment of the present disclosure, and FIG. 3 is a diagram showing a state in which a smoke suctioning and fire extinguishing fluid discharge pipe of the fire extinguishing system according to an embodiment of the present disclosure is provided within a PE compartment.

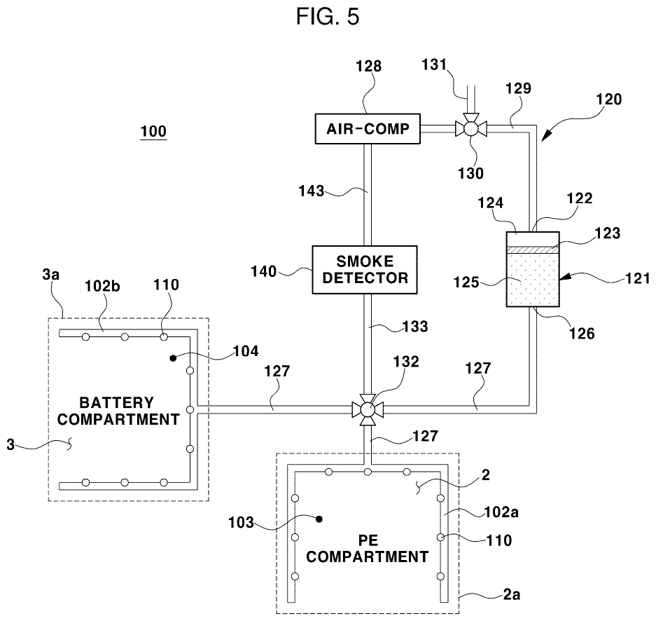

The fire extinguishing system according to an embodiment of the present disclosure may be configured in a PE compartment 2 (fire response space) at the rear of a vehicle 1, and a smoke suctioning and fire extinguishing fluid discharge pipe 102a is provided in the PE compartment 2. The smoke suctioning and fire extinguishing fluid discharge pipe 102a may be provided in an upper structure 2a (in FIG. 5) inside the PE compartment 2.

The smoke suctioning and fire extinguishing fluid discharge pipe 102a is a member that suctions smoke for fire detection within the PE compartment 2 and supplies, sprays, and discharges a fire extinguishing fluid for fire suppression.

In the present embodiment, the smoke suctioning and fire extinguishing fluid discharge pipe 102a may be provided in an approximately U-shape (see FIG. 5) in an upper space within the PE compartment 2 to spray the fire extinguishing fluid downwardly toward automotive electronics (PE components) within the PE compartment 2.

In the present embodiment, the smoke suctioning and fire extinguishing fluid discharge pipe 102a may have a plurality of nozzles 110, and may forcibly suction smoke generated by fire in the PE compartment 2 together with air through each nozzle 110.

In the present disclosure, in a case where fire in the PE compartment 2 is detected using a smoke detector 140 from smoke forcibly suctioned through the smoke suctioning and fire extinguishing fluid discharge pipe 102a, the fire extinguishing fluid is supplied through the smoke suctioning and fire extinguishing fluid discharge pipe 102a, so that the fire extinguishing fluid is sprayed and discharged through the nozzle 110 into the PE compartment 2.

Further, the fire extinguishing system according to an embodiment of the present disclosure may further include a temperature sensor 103 provided in the PE compartment 2 (a first fire response space). In an embodiment of the present disclosure, a plurality of sensors 103 may be provided in the PE compartment 2.

The PE compartment temperature sensor 103 is a sensor to be used for fire detection, and a controller 101 determines whether to enter a PE compartment fire detection mode (to be described below) on the basis of a signal of the PE compartment temperature sensor 103. The PE compartment fire detection mode is a mode for checking whether smoke due to fire is generated in the PE compartment 2.

The controller 101 primarily determines whether a PE compartment smoke detection condition is satisfied from the signal of the PE compartment temperature sensor 103. In a case where it is determined that the PE compartment smoke detection condition is satisfied, the controller 101 performs entry to the fire detection mode that is a mode for detecting smoke generated due to fire in the PE compartment 2.

FIG. 4 is a diagram showing a state in which a smoke suctioning and fire extinguishing fluid discharge pipe of a fire extinguishing system according to an embodiment of the present disclosure is provided in a battery compartment. The fire extinguishing system according to an embodiment of the present disclosure may be configured in a battery compartment 3 (a second fire response space) on an upper side of a vehicle roof, and a smoke suctioning and fire extinguishing fluid discharge pipe 102b may be provided in the battery compartment 3.

Referring to FIG. 4, it can be seen that a battery pack assembly 4 is provided at front and rear positions in a front-back direction of the vehicle, and the smoke suctioning and fire extinguishing fluid discharge pipe 102b having an approximately U-shape is provided together with heat management components such as a cooling fan 9 of a cooling module.

The smoke suctioning and fire extinguishing fluid discharge pipe 102b suctions smoke to detect fire in the battery compartment 3, and supplies, sprays, and discharges the fire extinguishing fluid to suppress the fire. The smoke suctioning and fire extinguishing fluid discharge pipe 102b may be provided in an upper space within the battery compartment 3.

The smoke suctioning and fire extinguishing fluid discharge pipe 102b may be provided in the approximately U-shape in the upper space within the battery compartment 3 so as to spray the fire extinguishing fluid downwardly toward the battery pack assembly 4 and parts thereof in the battery compartment 3.

For example, the smoke suctioning and fire extinguishing fluid discharge pipe 102b may be provided in a structure 3a (in FIG. 5) such as a battery cover located in the upper space within the battery compartment 3.

In an embodiment of the present disclosure, the smoke suctioning and fire extinguishing fluid discharge pipe 102b in the battery compartment 3 may have a plurality of nozzles 110 for smoke suction, and may suction smoke generated in the battery compartment 3 when a fire breaks out together with air through each nozzle 110.

In a case where the fire in the battery compartment 3 is detected using the smoke detector 140 from the smoke suctioned through the smoke suctioning and fire extinguishing fluid discharge pipe 102b, the fire extinguishing fluid is supplied through the smoke suctioning and fire extinguishing fluid discharge pipe 102b so that the fire extinguishing fluid can be sprayed and discharged through each nozzle 110 within the battery compartment 3. In the case of the battery compartment 3, a large amount of flammable gas is generated and released when fire occurs, and a smoke detector is suitable as a sensor for early detection of the fire.

In the case of the battery compartment 3, as in the case of the PE compartment 2, the cooling fan 9 of the cooling module is mounted at the front of the vehicle 1 to generate forced convection of air, and suctions outside air from the front of the vehicle 1 and supplies the air to the rear. Thus, the direction of forced convection is a direction in which the air moves from the front to the rear as shown in FIG. 4.

When the cooling fan is operated, since the forced convection of air occurs within the battery compartment 3, in a case where the smoke detector 140 (in FIG. 2) for fire detection is provided within the battery compartment 3, smoke from fire may not flow to the smoke detector 140 due to the forced convection of air by the cooling fan, and thus, the smoke detector 140 may not detect the occurrence of the fire in time.

Accordingly, as in the PE compartment 2, the smoke suctioning and fire extinguishing fluid discharge pipe 102b is provided in the battery compartment 3, so that smoke generated by fire is forcibly suctioned into the smoke suctioning and fire extinguishing fluid discharge pipe 102b and then detected by the smoke detector 140 on a pipe (smoke detection pipe) connected to the smoke suctioning and fire extinguishing fluid discharge pipe, thereby enabling smoke to be accurately detected at the time of fire in the space, regardless of the operation of the cooling fan 9 or the occurrence of forced convection.

The smoke detector 140 may be provided in a location that is not affected by forced convection by the cooling fan 9, and for example, may be provided outside the PE compartment 2 and the battery compartment 3, not inside the PE compartment 2 and the battery compartment 3.

In the present disclosure, there is no difference in the operating state, function, or use of the smoke suctioning and fire extinguishing fluid discharge pipe 102a or 102b between a case where it is provided in the PE compartment 2 and a case where it is provided in the battery compartment 3. In other words, the smoke suctioning and fire extinguishing fluid discharge pipe 102a or 102b has the same function and operation in a case where it is provided in the PE compartment 2 and in a case where it is provided in the battery compartment 3.

Further, the fire extinguishing system according to an embodiment of the present disclosure may further include a temperature sensor 104 provided in the battery compartment 3 (a second fire response space). In an embodiment of the present disclosure, a plurality of sensors 104 may be provided in the battery compartment 3.

The battery compartment temperature sensor 104 is a sensor to be used for fire detection, and the controller 101 determines whether to enter a battery compartment fire detection mode (to be described below) on the basis of a signal of the battery compartment temperature sensor 104. The battery compartment fire detection mode is a mode for checking whether smoke due to fire is generated in the battery compartment 3.

The controller 101 primarily determines whether a battery compartment smoke detection condition is satisfied from the signal of the battery compartment temperature sensor 104. In a case where it is determined that the battery compartment smoke detection condition is satisfied, the controller 101 performs the entry to the fire detection mode that is a mode for detecting smoke generated due to fire in the battery compartment 3.

FIG. 5 is a diagram showing a configuration of a fire extinguishing system according to an embodiment of the present disclosure, and shows an example in which the PE compartment 2 and the battery compartment 3 are set as a fire response space for suppressing fire in the vehicle.

The vehicle may be an electric vehicle or a fuel cell vehicle. In the present disclosure, the fire response space may include one or two of the PE compartment 2 and the battery compartment 3.

More specifically, in the present disclosure, the smoke suctioning and fire extinguishing fluid discharge pipe 102a or 102b may be provided in the PE compartment 2 or the battery compartment 3 that is set as the fire response space in the vehicle, or may be provided in both the PE compartment 2 and the battery compartment 3.

In FIG. 5, one PE compartment 2 and one battery compartment 3 are set as the fire response spaces of the vehicle where an extinguishing fluid is sprayed by the fire extinguishing system 100, but the number of PE compartments and the number of battery compartments may be variously changed. In other words, a plurality of PE compartments 2 and a plurality of battery compartments 3 may be set as the fire response spaces.

Further, only a plurality of PE compartments 2 or only a plurality of battery compartments 3 may be set as the fire response spaces. Furthermore, fire response spaces other than the PE compartment 2 and the battery compartment 3 may be set in the vehicle.

In this way, the smoke suctioning and fire extinguishing fluid discharge pipe 102a or 102b may be provided in the fire response space set in advance in the vehicle 1 to extinguish fire. To this end, as described above, one or more fire response spaces may be provided.

As shown in FIG. 5, the smoke suctioning and fire extinguishing fluid discharge pipe 102a or 102b may be provided in an approximately U-shape on a PE compartment structure 2a or a battery compartment structure 3a, and a plurality of nozzles 110 that sprays a fire extinguishing fluid may be provided at preset intervals in the length direction.

In the smoke suctioning and fire extinguishing fluid discharge pipe 102a or 102b, the nozzles 110 may be provided at regular intervals in the length direction, and the smoke suctioning and fire extinguishing fluid discharge pipe 102a or 102b and the nozzles 110 may be provided in the upper space within the PE compartment 2 and the battery compartment 3 so as to spray the fire extinguishing fluid downwardly toward the automotive electronics (PE components) or battery pack assembly where fire has occurred.

A fire extinguishing fluid supply pipe 127 is connected to the smoke suctioning and fire extinguishing fluid discharge pipes 102a and 102b provided in the respective fire response spaces of the PE compartment 2 and the battery compartment 3. Further, the fire extinguishing fluid supply pipe 127 is connected to a fire extinguishing fluid supply device 120.

In other words, the fire extinguishing fluid supply pipe 127 is extended to each fire response space of the PE compartment 2 and the battery compartment 3 to supply the fire extinguishing fluid from the fire extinguishing fluid supply device 120, and is connected to the smoke suctioning and fire extinguishing fluid discharge pipes 102a and 102b.

The fire extinguishing fluid supply pipe 127 that is extended from the fire extinguishing fluid supply device 120 is branched to the smoke suctioning and fire extinguishing fluid discharge pipes provided in the respective fire response spaces, i.e., the smoke suctioning and fire extinguishing fluid discharge pipe 102a in the PE compartment 2 and the smoke suctioning and fire extinguishing fluid discharge pipe 102b in the battery compartment 3, as shown in FIG. 5.

In addition, a smoke detection pipe 133 is branched at a location where the fire extinguishing fluid supply pipe 127 is branched, and the branched smoke detection pipe 133 is connected to an inlet of the smoke detector 140. Further, a suction pipe 143 is connected between an outlet of the smoke detector 140 and an intake port of the air compressor 128.

A control valve 132 is provided at a location where the fire extinguishing fluid supply pipe 127 connected from the fire extinguishing fluid supply device 120 is branched toward the PE compartment 2 and the battery compartment 3, which is also a location where the smoke detection pipe 133 is branched from the fire extinguishing fluid supply pipe 127.

The control valve 132 is a valve that controls a flowing direction of the fire extinguishing fluid in the fire extinguishing fluid supply pipe 127 so that the fire extinguishing fluid supplied from the fire extinguishing fluid supply device 120 is supplied to the fire response space where smoke is detected according to a control signal output by the controller 101.

In an embodiment of the present disclosure, the control valve 132 may be a 4-way valve according to the number of branches as a multi-way valve, and more specifically, an electronic 4-way valve, an opening state of which is controlled by the controller 101.

Further, in an embodiment of the present disclosure, the fire extinguishing fluid supply device 120 is configured to include a fire extinguishing fluid tank 121 in which the fire extinguishing fluid is stored, and a pressure transfer plate 123 that pressurizes the fire extinguishing fluid by pressure of a working fluid supplied to a pressure chamber 124 of the fire extinguishing fluid tank 121 to discharge the fire extinguishing fluid to the fire extinguishing fluid supply pipe 127 in a high-pressure state.

The pressure transfer plate 123 is provided transversely in an internal space of the fire extinguishing fluid tank 121 to divide the internal space of the fire extinguishing fluid tank 121 into front and rear sections. In particular, the pressure transfer plate 123 is provided to move forward and backward in the internal space of the fire extinguishing fluid tank 121.

In the internal space of the fire extinguishing fluid tank 121, among two spaces divided by the pressure transfer plate 123, i.e., a space in front of the pressure transfer plate 123 is a fire extinguishing fluid chamber 125 that is filled with the fire extinguishing fluid, and a space behind the pressure transfer plate 123 is the pressure chamber 124 where the working fluid is supplied and the pressure of the working fluid is applied.

The working fluid may be compressed air supplied by the air compressor 128. To this end, an air inlet port 122 connected to the pressure chamber 124 is provided at a rear end portion of the fire extinguishing fluid tank 121 where the pressure chamber 124 is located at the rear of the pressure transfer plate 123, and an air supply pipe 129 through which compressed air is supplied from the air compressor 128 is connected to the air inlet port 122.

The air supply pipe 129 is connected between an outlet (not shown) through which compressed air is discharged from the air compressor 128 and the air inlet port 122 of the fire extinguishing fluid tank 121. An exhaust valve 130 is provided in the middle of the air supply pipe 129.

The exhaust valve 130 may be a 3-way valve as a multi-way valve, and more specifically, an electronic 3-way valve, an opening state of which is controlled by the controller 101. An exhaust port 131 that is selectively connected to the air supply pipe 129 according to the opening state of the valve is provided in the exhaust valve 130.

The fire extinguishing fluid supply pipe 127 is connected to a fire extinguishing fluid outlet port 126 provided in the fire extinguishing fluid chamber 125 in front of the pressure transfer plate 123 in the fire extinguishing fluid tank 121. The fire extinguishing fluid supply pipe 127 is connected to the fire response spaces, i.e., the PE compartment 2 and the battery compartment 3.

Specifically, the fire extinguishing fluid supply pipe 127 is extended from the fire extinguishing fluid outlet port 126 of the fire extinguishing fluid tank 121 and is branched toward each fire response space of the PE compartment 2 and the battery compartment 3 through the control valve 132, and the branched fire extinguishing fluid supply pipes 127 are connected to the smoke suctioning and fire extinguishing fluid discharge pipes 102a and 102b provided in the PE compartment 2 and the battery compartment 3, respectively.

Accordingly, the fire extinguishing fluid in the fire extinguishing fluid tank 121 may be discharged through the fire extinguishing fluid outlet port 126 to the fire extinguishing fluid supply pipe 127, and then, may move along the fire extinguishing fluid supply pipe 127 to be supplied to the smoke suctioning and fire extinguishing fluid discharge pipe 102a and 102b in the fire response spaces (PE compartment and battery compartment).

Then, the fire extinguishing fluid supplied to the smoke suctioning and fire extinguishing fluid discharge pipe 102a or 102b may be sprayed into the interior of the fire response space through the nozzle 110 provided at each location, thereby making it possible to extinguish fire using the fire extinguishing fluid.

In the present disclosure, the air compressor 128 is a component that provides suction pressure for fire detection to the smoke suctioning and fire extinguishing fluid discharge pipes 102a and 102b, and is a component that supplies the working fluid to the fire extinguishing fluid tank 121 of the fire extinguishing fluid supply device. The operation of the air compressor 128 is controlled by a control signal output from the controller 101, as well as the control valve 132 and the exhaust valve 130 (see FIG. 2).

In the present disclosure, in a case where it is determined that fire occurs in a fire response space from an electrical signal input from the smoke detector 140, the controller 101 outputs a control signal for fire suppression. Accordingly, the operations of the air compressor 128 and the multi-way valves 130 and 132 are controlled to extinguish the fire occurring in the fire response space according to the control signal.

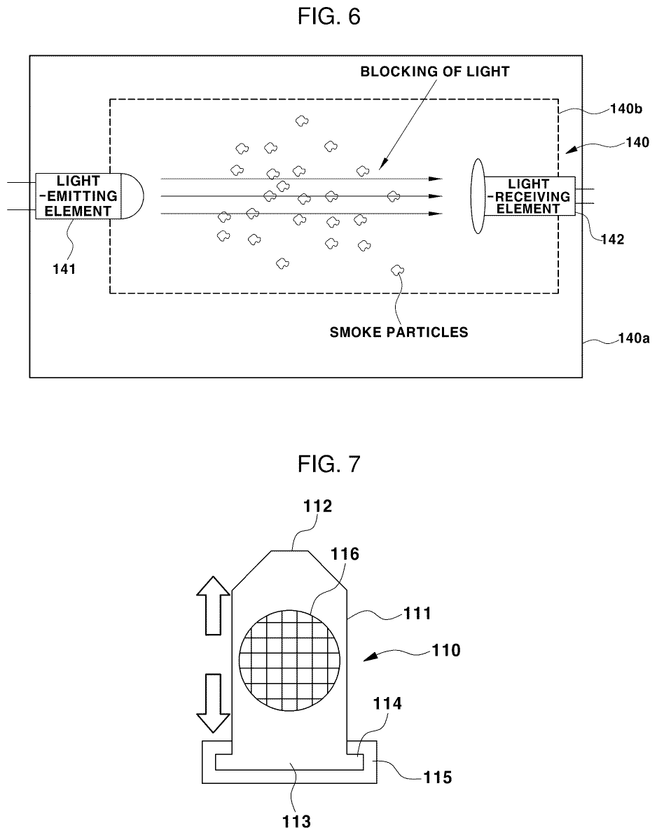

FIG. 6 is a diagram showing a photoelectric smoke detector having a light-emitting element and a light-receiving element according to an embodiment of the present disclosure. An operating principle of the smoke detector 140 is described with reference to FIG. 6.

In the present disclosure, the smoke detector 140 may include a housing 140a that is connected to the smoke detection pipe 133 and has a sensing chamber 140b through which air or air containing smoke is flowing through the smoke detection pipe 133 passes, and a smoke detection sensor that is provided in an internal space of the housing 140a and detects smoke in the air passing through the sensing chamber 140b and outputs an electrical signal indicating the detection result.

In an embodiment of the present disclosure, the smoke detection sensor may be a photoelectric sensor, and the smoke detector 140 may be a photoelectric smoke detector. The photoelectric sensor uses the principle that smoke particles block or reflect light, and may be configured to include a light-emitting element 141 and a light-receiving element 142.

As shown in FIG. 6, the photoelectric sensor may include the light-emitting element 141 provided on one side of the sensing chamber 140b of the housing 140a, and the light-receiving element 142 provided on the other side of the sensing chamber 140b of the housing 140a opposite the light-emitting element 141 to convert light received from the light-emitting element 141 into an electrical signal and output the result.

In an embodiment of the present disclosure, the housing 140a includes the sensing chamber 140b through which air or air containing smoke is flowing through the smoke detection pipe 133 from the fire response spaces of the PE compartment 2 and the battery compartment 3 passes, and the light-emitting element 141 and the light-receiving element 142 may be provided to face each other in the sensing chamber 140b.

The light-receiving element 142 is provided to output an electrical signal according to the concentration of smoke particles contained in the air having passed through the sensing chamber 140b of the housing 140a. The electrical signal output from the light-receiving element 142 is input to the controller 101, and the controller 101 determines whether fire occurs on the basis of the electrical signal received from the light-receiving element 142.

The controller 101 determines the concentration of smoke particles in the air having passed through the sensing chamber 140b of the housing 140a on the basis of the electrical signal received from the smoke detector 140, and then determines whether fire occurs on the basis of the concentration of smoke particles. The controller 101 may determine that fire occurs in a case where the concentration of smoke particles is equal to or greater than a set value.

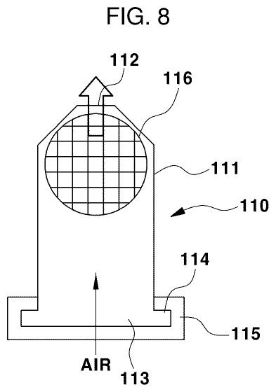

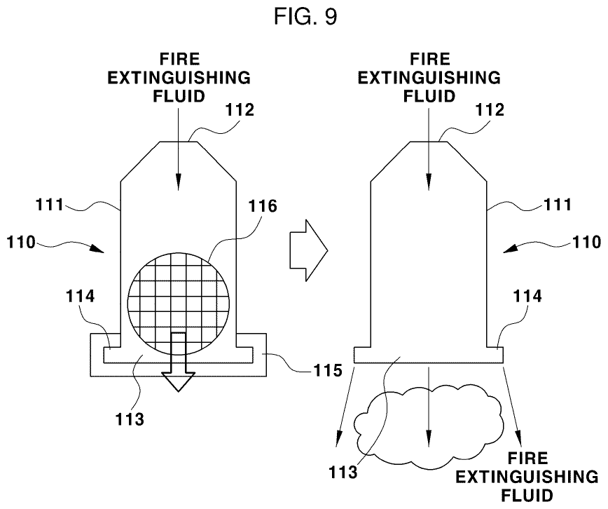

FIG. 7 is a diagram showing a configuration of a nozzle provided in a smoke suctioning and fire extinguishing fluid discharge pipe according to an embodiment of the present disclosure, FIG. 8 is a diagram showing an operating state of the nozzle in a fire detection mode according to an embodiment of the present disclosure, and FIG. 9 is a diagram showing an operating state of the nozzle when spraying a fire extinguishing fluid according to an embodiment of the present disclosure.

The nozzle 110 is fixedly provided in each of the smoke suctioning and fire extinguishing fluid discharge pipes 102a and 102b in the PE compartment 2 and the battery compartment 3, which are fire response spaces, and is used for two purposes in the present disclosure, i.e., smoke suctioning and fire extinguishing fluid spraying.

In an embodiment of the present disclosure, the nozzle 110 may be equipped with filter members 115 and 116 capable of removing fine dust from air or air and smoke suctioned through the nozzle 110 and the smoke-suctioning and extinguishing fluid discharge pipes 102a and 102b in the fire detection mode.

In a case where there are no filter members 115 and 116 to remove fine dust inside the nozzle when smoke is suctioned through the nozzle 110 in the fire detection mode, the performance of the smoke detector 140 may deteriorate due to the fine dust suctioned together with the smoke, thereby lowering the fire detection performance.

On the other hand, in spraying the fire extinguishing fluid through the nozzle 110, in a case where the filter members 115 and 116 are provided inside the nozzle, the filter members may block the passage of the fire extinguishing fluid inside the nozzle or interfere with the passage of the fire extinguishing fluid, which may lower the fire extinguishing fluid spraying performance.

Therefore, in the fire detection mode where air (or air containing smoke) is normally suctioned through the nozzle, the filter members 115 and 116 should be normally provided inside the nozzle 110, and in spraying the fire extinguishing fluid, it is necessary to ensure that the filter members 115 and 116 are easily separated from the nozzle 110 by the sprayed fire extinguishing fluid.

Referring to FIG. 7, the nozzle 110 may be configured to include a nozzle pipe 111 having a first end portion 112 connected to communicate with the inside of each of the smoke suctioning and fire extinguishing fluid discharge pipes 102a and 102b (FIG. 5) and a second end portion 113 on the opposite side disposed to face a device or component with a risk of fire within the PE compartment 2 or the battery compartment 3, which is the fire response space; a first filter member 115 that is detachably provided to cover the second end portion 113 of the nozzle pipe 111 and primarily removes fine dust; and a second filter member 116 that is provided inside the nozzle pipe 111, is provided to move back and forth (in an up-down direction in the figure) toward the first end portion 112 and the second end portion 113, and secondarily removes fine dust.

In the nozzle 110 having the above-mentioned configuration, the first end portion 112 is a portion connected to the smoke suctioning and fire extinguishing fluid discharge pipe 102a or 102b, and is configured so that a cross-sectional area of the portion directly connected to the smoke suctioning and fire extinguishing fluid discharge pipe 102a or 102b is smaller than a cross-sectional area of the nozzle pipe 111.

For example, as shown in FIG. 7, the first end portion 112 may have a pipe shape in which the cross-sectional area gradually decreases from the nozzle pipe 111 to the portion connected to each smoke suctioning and fire extinguishing fluid discharge pipe (102a and 102b in FIG. 5).

In an embodiment of the present disclosure, the first filter member 115 may be a mesh net (e.g., wire mesh) having a relatively large mesh size, and may be provided at the second end portion 113 of the nozzle pipe 111 so as to be detached by the fire extinguishing fluid sprayed in fire suppression.

In other words, the first filter member 115 is provided transversely at the second end portion 113, which is an outlet part of the fire extinguishing fluid of the nozzle pipe 111 and a suction part of air (or air containing smoke), and is coupled to an outer position of the nozzle pipe 111 so as to be detached from the second end portion 113 by the fire extinguishing fluid having passed through the inside of the nozzle pipe 111 for fire suppression.

A flange portion 114 having an outwardly extended shape is formed on the second end portion 113 of the nozzle pipe 111, and the first filter member 115 may be fixedly combined with the flange portion 114 so that an edge portion of the first filter member 115 surrounds the flange portion 114 while being horizontally disposed on the second end portion 113 of the nozzle pipe 111.

In an embodiment of the present disclosure, the second filter member 116 is provided between the first end portion 112 and the second end portion 113 inside the nozzle pipe 111, and removes foreign substances such as fine dust having passed through the first filter member 115.

In an embodiment of the present disclosure, the second filter member 116 may be a ball-shaped member formed of a mesh structure. The ball-shaped second filter element 116 is provided to move freely in the space within the nozzle pipe 111 between the first end portion 112 and the second end portion 113.

In an embodiment of the present disclosure, the second filter member 116 may be a ball-shaped member having a mesh size smaller than that of the first filter member 115, and may be a member formed by bending or rolling a thin wire or the like in a ball shape.

The second filter element 116, similar to the first filter element 115, is intended to maintain the performance of the smoke detector 140 by removing the foreign substances such as fine dust from the suctioned air, and also plays a role of detaching the first filter element 115 when spraying the fire extinguishing fluid.

As shown in FIG. 8, in a case where air is suctioned through the suction pipe 143, the smoke detection pipe 133, and the smoke suctioning and fire extinguishing fluid discharge pipe 102a or 102b by the air compressor 128, the ball-shaped second filter member 116 is positioned on the side of the first end portion 112 connected to the smoke suctioning and fire extinguishing fluid discharge pipe 102a or 102b by the suction pressure within the nozzle pipe 111.

The ball-shaped second filter element 116 is positioned to block the internal passage of the nozzle pipe 111, but allows air and smoke to pass therethrough due to its mesh structure, and removes fine dust from the air being suctioned in case of fire while allowing smoke and air to pass therethrough, thereby maintaining the performance of the smoke detector 140.

On the other hand, in a case where the fire extinguishing fluid is sprayed, as shown in FIG. 9, the fire extinguishing fluid supplied through the smoke suctioning and fire extinguishing fluid discharge pipe 102a or 102b passes through the inside of the nozzle pipe 111, and strongly pushes the ball-shaped second filter member 116.

The second filter member 116 causes an impact while strongly pushing the first filter member 115 together with the fire extinguishing fluid, and thus, the first filter member 115 is detached from the second end portion 113, which is the outlet part of the fire extinguishing fluid of the nozzle pipe 111, by the second filter member 116. In a case where the first filter element 115 is detached from the nozzle pipe 111, the second filter element 116 also comes out of the nozzle pipe 111 and is detached.

In this way, the second filter member 116 removes foreign substances and also detaches the first filter member 115 from the nozzle pipe 111. In spraying the fire extinguishing fluid, the second filter member 116 pushes the first filter member 115 outward to detach the first filter member 115, thereby maintaining a strong extinguishing fluid spray pressure at the nozzle 110.

The configuration of the fire extinguishing system according to an embodiment of the present disclosure has been described in detail, and an operating state of the fire extinguishing system is described.

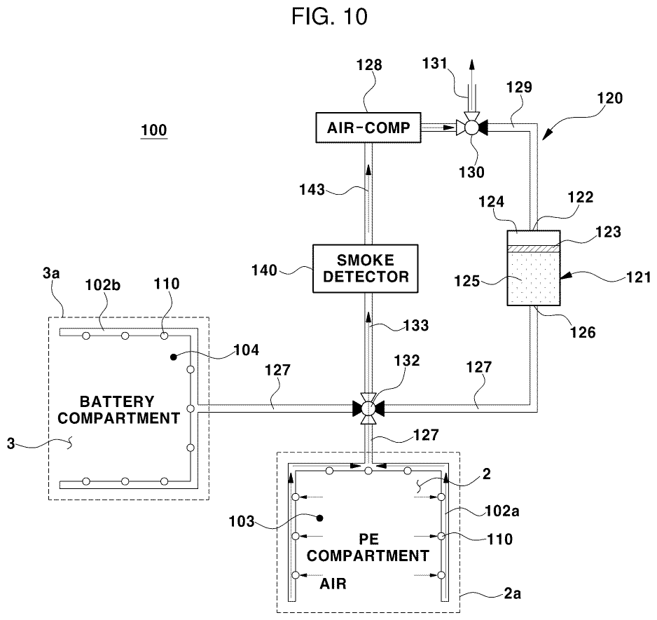

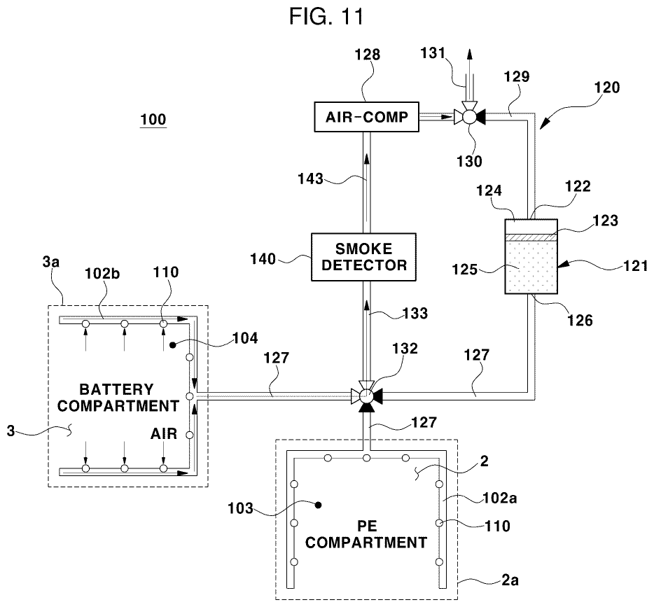

FIGS. 10 and 11 are diagrams showing operating states in the fire detection mode of the fire extinguishing system according to an embodiment of the present disclosure, in which FIG. 10 is a diagram showing an operating state in a PE compartment fire detection mode and FIG. 11 is a diagram showing an operating state in a battery compartment fire detection mode.

The controller 101 determines whether a PE compartment smoke detection condition is satisfied from a signal of the PE compartment temperature sensor 103 to determine whether to enter the fire detection mode for the PE compartment 2 from the signal of the PE compartment temperature sensor 103, and executes the PE compartment fire detection mode in a case where the PE compartment smoke detection condition is satisfied.

In addition, the controller 101 determines whether the battery compartment smoke detection condition is satisfied from a signal of the battery compartment temperature sensor 104 to determine whether to enter the fire detection mode for the battery compartment 3 from the signal of the battery compartment temperature sensor 104, and executes the battery compartment fire detection mode in a case where the battery compartment smoke detection condition is satisfied.

The fire detection mode is a mode for detecting fire that occurs within a fire response space in the vehicle 1, such as the PE compartment 2 and the battery compartment 3, and detects fire by detecting smoke that is generated within each fire response space (detecting the smoke concentration in the air). In order to detect the smoke in the fire detection mode, the air compressor 128 is operated to apply suction pressure of the air compressor 128 to the PE compartment 2 and the battery compartment 3.

First, as shown in FIG. 10, in the PE compartment fire detection mode, the controller 101 operates the air compressor 128 to detect smoke generated in the PE compartment 2.

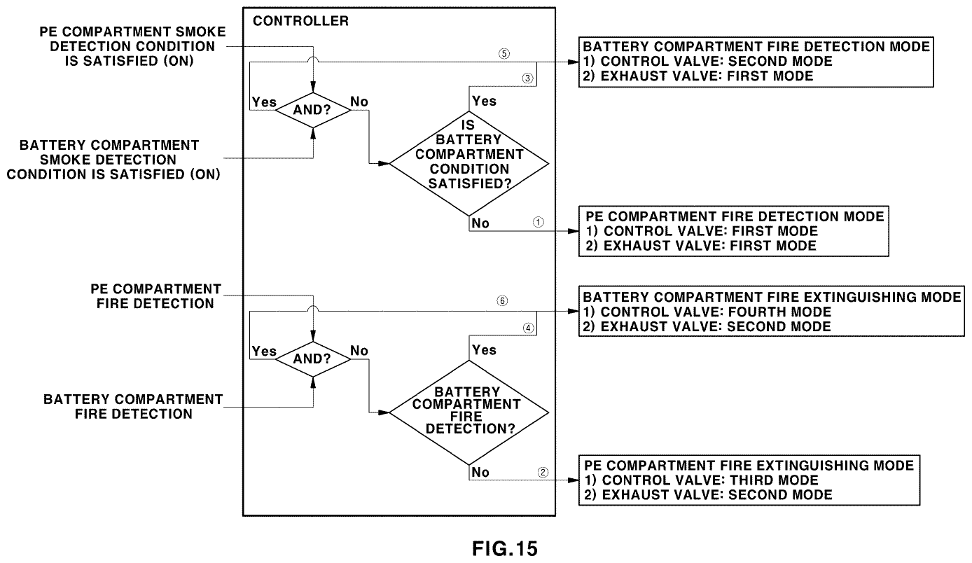

Further, the controller 101 controls an opening state of the control valve 132 to connect the smoke detection pipe 133 in which the smoke detector 140 is provided and the fire extinguishing fluid supply pipe 127 connected to the PE compartment 2, and blocks the fire extinguishing fluid supply pipe 127 connected from the fire extinguishing fluid supply device 120 and the fire extinguishing fluid supply pipe 127 connected to the battery compartment 3 (a “first mode” of the control valve in FIG. 15).

In addition, the controller 101 controls the opening state of the exhaust valve 130 to open the exhaust port 131 and block the air supply pipe 129 connected to the fire extinguishing fluid supply device 120 (a “first mode” of the exhaust valve in FIG. 15).

As a result, the suction pressure of the air compressor 128 is applied to the PE compartment 2 through the suction pipe 143, the smoke detector 140, the smoke detection pipe 133, the control valve 132, the fire extinguishing fluid supply pipe 127 connected to the PE compartment 2, the smoke suctioning and fire extinguishing fluid discharge pipe 102a provided in the PE compartment 2, and the nozzle 110.

While the suction pressure is applied, air inside the PE compartment 2 passes through the nozzle 110, the smoke suctioning and fire extinguishing fluid discharge pipe 102a, the fire extinguishing fluid supply pipe 127, the control valve 132, the smoke detection pipe 133, the smoke detector 140, the suction pipe 143, and the air compressor 128, and then is discharged to the atmosphere through the air supply pipe 129 and the exhaust port 131 of the exhaust valve 130.

In a case where fire breaks out inside the PE compartment 2, smoke generated due to the fire flows in together with air from the PE compartment 2 where the fire breaks out, and this smoke moves together with the air through the nozzle 110, the smoke suctioning and fire extinguishing fluid discharge pipe 102a, the fire extinguishing fluid supply pipe 127 connected to the PE compartment 2, the control valve 132, and the smoke detection pipe 133, and passes through the smoke detector 140.

Accordingly, an electrical signal output from the smoke detector 140 is input to the controller 101, and the controller 101 may detect the fire occurring in the PE compartment 2 on the basis of the electrical signal from the smoke detector 140.

In a case where air is suctioned through each nozzle 110 of the smoke suctioning and fire extinguishing fluid discharge pipe 102a in the PE compartment 2, smoke and air are suctioned together in the PE compartment 2 where the fire occurs. Particularly, while air or air and smoke are suctioned through each nozzle 110 provided in the smoke suctioning and fire extinguishing fluid discharge pipe 102a, fine dust is filtered out and removed by the first filter member 115 and the second filter member 116.

In a case where the fire that occurs in the PE compartment 2 is detected as described above, the controller 101 performs the PE compartment fire extinguishing mode to extinguish the fire that occurs in the PE compartment 2 by supplying the fire extinguishing fluid charged in the fire extinguishing fluid tank 121 of the fire extinguishing fluid supply device 120 to the PE compartment 2 through the fire extinguishing fluid supply pipe 127.

Then, as shown in FIG. 11, in the battery compartment fire detection mode, the controller 101 operates the air compressor 128 to detect smoke generated in the battery compartment 3.

In addition, the controller 101 controls the opening state of the control valve 132 to connect the smoke detection pipe 133 in which the smoke detector 140 is provided and the fire extinguishing fluid supply pipe 127 connected to the battery compartment 3, and block the fire extinguishing fluid supply pipe 127 connected from the fire extinguishing fluid supply device 120 and the fire extinguishing fluid supply pipe 127 connected to the PE compartment 2 (a “second mode” of the control valve in FIG. 15).

Further, the controller 101 controls the opening state of the exhaust valve 130 to open the exhaust port 131 and block the air supply pipe 129 connected to the fire extinguishing fluid supply device 120 (the “first mode” of the exhaust valve in FIG. 15).

As a result, the suction pressure of the air compressor 128 is applied to the battery compartment 3 through the suction pipe 143, the smoke detector 140, the smoke detection pipe 133, the control valve 132, the fire extinguishing fluid supply pipe 127 connected to the battery compartment 3, the smoke suctioning and fire extinguishing fluid discharge pipe 102b provided in the battery compartment 3, and the nozzle 110.

While the suction pressure is applied, the air inside the battery compartment 3 passes through the nozzle 110, the smoke suctioning and fire extinguishing fluid discharge pipe 102b, the control valve 132, the smoke detection pipe 133, the smoke detector 140, the suction pipe 143, and the air compressor 128, and then is discharged into the atmosphere through the air supply pipe 129 and the exhaust port 131 of the exhaust valve 130.

In a case where fire breaks out inside the battery compartment 3, smoke generated due to the fire flows in through the nozzle 110 together with air from the battery compartment 3 where the fire breaks out, and this smoke moves together with the air through the smoke suctioning and fire extinguishing fluid discharge pipe 102b, the fire extinguishing fluid supply pipe 127 connected to the battery compartment 3, the control valve 132, and the smoke detection pipe 133, and passes through the smoke detector 140.

Accordingly, an electrical signal output from the smoke detector 140 is input to the controller 101, and the controller 101 may detect the fire occurring in the battery compartment 3 on the basis of the electrical signal from the smoke detector 140.

In a case where air is suctioned through each nozzle 110 of the smoke suctioning and fire extinguishing fluid discharge pipe 102b in the battery compartment 3, smoke and air are suctioned together in the battery compartment 3 where the fire occurs. Particularly, while air or air and smoke are suctioned through each nozzle 110 provided in the smoke suctioning and fire extinguishing fluid discharge pipe 102b, fine dust is filtered out and removed by the first filter member 115 and the second filter member 116.

In a case where the fire that occurs in the battery compartment 3 is detected as described above, the controller 101 supplies the fire extinguishing fluid charged in the fire extinguishing fluid tank 121 of the fire extinguishing fluid supply device 120 to the battery compartment 3 through the fire extinguishing fluid supply pipe 127 to perform the battery compartment fire extinguishing mode to extinguish the fire occurring in the battery compartment 3.

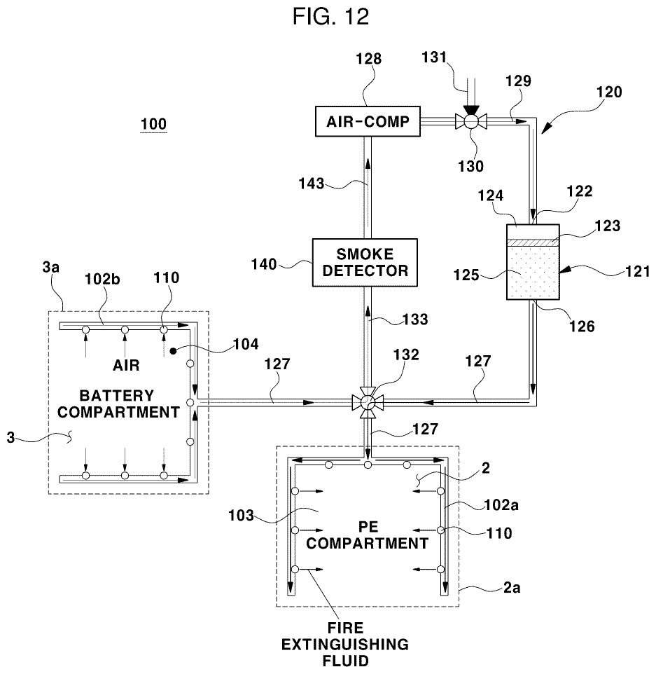

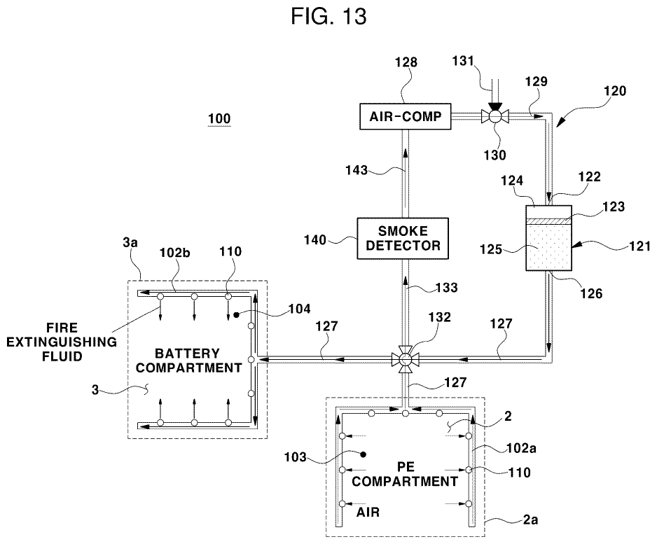

Hereinafter, the fire extinguishing mode is described. FIG. 12 and FIG. 13 are diagrams for illustrating operating states in the fire extinguishing mode of the fire extinguishing system according to an embodiment of the present disclosure, in which FIG. 12 shows an operating state in the PE compartment fire extinguishing mode and FIG. 13 shows an operating state in the battery compartment fire extinguishing mode.

As shown in FIG. 12, in order to supply an extinguishing fluid to the PE compartment 2 in the PE compartment fire extinguishing mode, the controller 101 controls the opening state of the control valve 132 to connect the fire extinguishing fluid supply pipe 127 connected to the battery compartment 3 and the smoke detection pipe 133 connected to the smoke detector 140, while connecting the fire extinguishing fluid supply pipe 127 connected from the fire extinguishing fluid supply device 120 and the fire extinguishing fluid supply pipe 127 connected to the PE compartment 2 (a “third mode” of the control valve in FIG. 15).

Further, the controller 101 controls the opening state of the exhaust valve 130 to block the exhaust port 131 and connect the air supply pipe 129 connected to an outlet of the air compressor 128 and the air supply pipe 129 connected to the fire extinguishing fluid supply device 120 (a “second mode” of the exhaust valve in FIG. 15).

In addition, the controller 101 operates the air compressor 128, and at this time, the suction pressure of the air compressor 128 is applied to the battery compartment 3 through the suction pipe 143, the smoke detector 140, the smoke detection pipe 133, the control valve 132, the fire extinguishing fluid supply pipe 127 connected to the battery compartment 3, the smoke suctioning and fire extinguishing fluid discharge pipe 102b in the battery compartment 3, and the nozzle 110.

As a result, air inside the battery compartment 3 is suctioned into the smoke suctioning and fire extinguishing fluid discharge pipe 102b through the nozzle 110, and then is suctioned into the air compressor 128 through the smoke suctioning and fire extinguishing fluid discharge pipe 102b, the fire extinguishing fluid supply pipe 127 connected to the battery compartment 3, the control valve 132, the smoke detection pipe 133, the smoke detector 140, and the suction pipe 143.

High-pressure compressed air discharged from the air compressor 128 may be supplied to the fire extinguishing fluid tank 121 through the exhaust valve 130 and the air supply pipe 129, and then supplied into the pressure chamber 124 of the fire extinguishing fluid tank 121 through the air inlet port 122.

Then, the pressure transfer plate 123 moves forward by the pressure of the compressed air supplied into the pressure chamber 124 of the fire extinguishing fluid tank 121 to pressurize the fire extinguishing fluid charged in the fire extinguishing fluid chamber 125 of the fire extinguishing fluid tank 121.

As a result, the fire extinguishing liquid in the fire extinguishing fluid chamber 125 is pressurized by the pressure transfer plate 123 and discharged through the fire extinguishing fluid outlet port 126 of the fire extinguishing fluid tank 121 into the fire extinguishing fluid supply pipe 127, and the fire extinguishing fluid flowing through the fire extinguishing fluid supply pipe 127 passes through the control valve 132 and is then supplied to the smoke suctioning and fire extinguishing fluid discharge pipe 102a in the PE compartment 2.

The fire extinguishing fluid supplied in this manner is sprayed into the PE compartment 2 through the nozzle 110 while moving along the smoke suctioning and fire extinguishing fluid discharge pipe 102a, to thereby extinguish the fire occurring in the PE compartment 2 by the sprayed extinguishing fluid.

In the smoke suctioning and fire extinguishing fluid discharge pipe 102a, the fire extinguishing fluid may be evenly sprayed into the PE compartment 2 through all nozzles 110, and when the fire extinguishing fluid is sprayed, as described above, the first filter member 115 and the second filter member 116 are detached from the nozzle pipe 111 by the fire extinguishing fluid, so that the fire extinguishing fluid can be smoothly sprayed through each nozzle 110.

Next, in the battery compartment fire extinguishing mode, as shown in FIG. 13, in order to supply the fire extinguishing fluid to the battery compartment 3, the controller 101 controls the opening state of the control valve 132 to connect the fire extinguishing fluid supply pipe 127 connected to the PE compartment 2 and the smoke detection pipe 133 connected to the smoke detector 140, while connecting the fire extinguishing fluid supply pipe 127 connected from the fire extinguishing fluid supply device 120 and the fire extinguishing fluid supply pipe 127 connected to the battery compartment 3 (a “fourth mode” of the control valve in FIG. 15).

In addition, the controller 101 controls the opening state of the exhaust valve 130 to block the exhaust port 131 and connect the air supply pipe 129 connected to the outlet of the air compressor 128 and the air supply pipe 129 connected to the fire extinguishing fluid supply device 120 (the “second mode” of the exhaust valve in FIG. 15).

Further, the controller 101 operates the air compressor 128, and at this time, the suction pressure of the air compressor 128 is applied inside the PE compartment 2 through the suction pipe 143, the smoke detector 140, the smoke detection pipe 133, the control valve 132, the fire extinguishing fluid supply pipe 127 connected to the PE compartment 2, the smoke suctioning and fire extinguishing fluid discharge pipe 102a inside the PE compartment 2, and the nozzle 110.

As a result, air inside the PE compartment 2 is suctioned into the smoke suctioning and fire extinguishing fluid discharge pipe 102a through the nozzle 110, and then suctioned into the air compressor 128 through the smoke suctioning and fire extinguishing fluid discharge pipe 102a, the fire extinguishing fluid supply pipe 127 connected to the PE compartment 2, the control valve 132, the smoke detection pipe 133, the smoke detector 140, and the suction pipe 143.

High-pressure compressed air discharged from the air compressor 128 may be supplied to the fire extinguishing fluid tank 121 through the exhaust valve 130 and the air supply pipe 129, and then supplied into the pressure chamber 124 of the fire extinguishing fluid tank 121 through the air inlet port 122.

Then, the pressure transfer plate 123 moves forward by the pressure of the compressed air injected into the pressure chamber 124 of the fire extinguishing fluid tank 121 to pressurize the fire extinguishing fluid charged in the fire extinguishing fluid chamber 125 of the fire extinguishing fluid tank 121.

As a result, the fire extinguishing fluid in the fire extinguishing fluid chamber 125 is pressurized by the pressure transfer plate 123 and discharged through the fire extinguishing fluid outlet port 126 of the fire extinguishing fluid tank 121 into the fire extinguishing fluid supply pipe 127, and the fire extinguishing fluid flowing through the fire extinguishing fluid supply pipe 127 passes through the control valve 132 and is then supplied to the smoke suctioning and fire extinguishing fluid discharge pipe 102b in the battery compartment 3.

The fire extinguishing fluid supplied in this manner is sprayed into the battery compartment 3 through the nozzle 110 while moving along the smoke suctioning and fire extinguishing fluid discharge pipe 102b, to thereby extinguish the fire occurring in the battery compartment 3 by the sprayed extinguishing fluid.

In the smoke suctioning and fire extinguishing fluid discharge pipe 102b, the fire extinguishing fluid may be evenly sprayed into the battery compartment 3 through all nozzles 110, and when the fire extinguishing fluid is sprayed, as described above, the first filter member 115 and the second filter member 116 are detached from the nozzle pipe 111 by the fire extinguishing fluid, so that the fire extinguishing fluid can be smoothly sprayed through each nozzle 110.

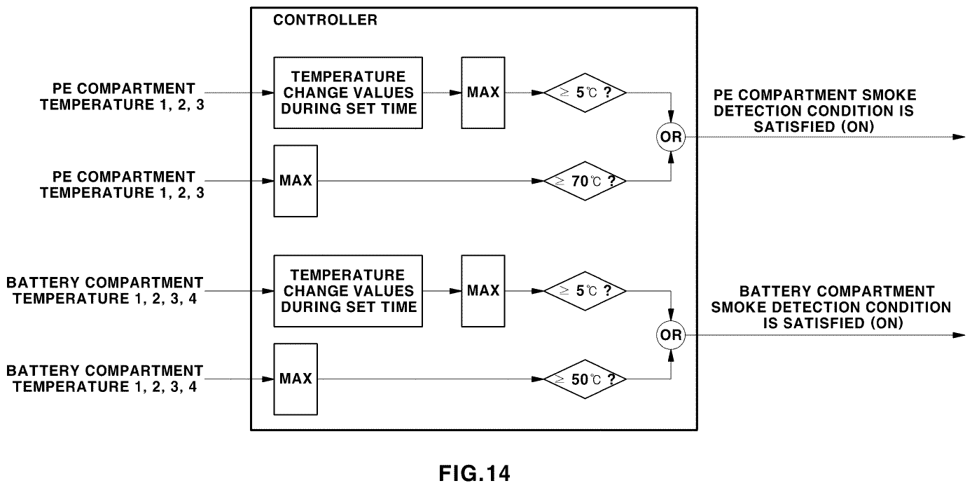

Then, a method of determining whether to enter the fire detection mode by the controller is described with reference to FIG. 14. The controller 101 primarily determines whether the PE compartment smoke detection condition is satisfied from a signal of the PE compartment temperature sensor 103. In a case where it is determined that the PE compartment smoke detection condition is satisfied, the controller 101 executes the PE compartment fire detection mode.

For example, in a case where three PE compartment temperature sensors 103 are provided, in a case where a maximum value of change values of temperatures (“PE compartment temperatures 1, 2, and 3”) detected by the three PE compartment temperature sensors 103 during a first set time (e.g., 10 seconds) is equal to or greater than a first reference value (e.g., 5° C.) preset in the controller 101, or in a case where a maximum value of the temperatures detected by the three PE compartment temperature sensors 103 is equal to or greater than a first reference temperature (e.g., 50° C.), it is determined that the PE compartment smoke detection condition is satisfied, and then, the controller 101 executes the PE compartment fire detection mode. The maximum value of change values of temperatures refers to the highest change value of the detected temperatures. The maximum value of the temperatures refers to the highest temperature value among the detected temperatures.

In addition, in the present embodiment, the controller 101 primarily determines whether the battery compartment smoke detection condition is satisfied from a signal of the battery compartment temperature sensor 104. In a case where it is determined that the battery compartment smoke detection condition is satisfied, the controller 101 executes the battery compartment fire detection mode.

For example, in a case where four battery compartment temperature sensors 104 are provided, in a case where a maximum value of change values of temperatures (“battery compartment temperatures 1, 2, 3, and 4”) detected by the four battery compartment temperature sensors 104 during a second set time (e.g., 10 seconds) is equal to or greater than a second reference value preset in the controller 101 (e.g., 5° C.), or in a case where a maximum value of the temperatures detected by the four battery compartment temperature sensors 104 is equal to or greater than a second reference temperature (e.g., 70° C.), it is determined that the battery compartment smoke detection condition is satisfied, and then, the controller 101 executes the battery compartment fire detection mode.

Next, a control state of the control valve and the exhaust valve by the controller, in the fire detection mode and the fire extinguishing mode, is described with reference to FIG. 15. In a case where the controller 101 determines that the PE compartment smoke detection condition is satisfied but the battery compartment smoke detection condition is not satisfied on the basis of the temperature of the PE compartment 2 detected by the PE compartment temperature sensor 103 and the temperature of the battery compartment 3 detected by the battery compartment temperature sensor 104 (case \textcircled{1} in FIG. 15), the controller 101 performs control for the PE compartment fire detection mode described in FIG. 10. In other words, the control valve 132 is controlled in the first mode, and the exhaust valve 130 is controlled in the first mode.

In a case where fire in the PE compartment 2 is detected from an electrical signal of the smoke detector 140 during the PE compartment fire detection mode (case \textcircled{2} in FIG. 15), the controller 101 performs control for the PE compartment fire extinguishing mode described in FIG. 12. In other words, the control valve 132 is controlled in the third mode, and the exhaust valve 130 is controlled in the second mode.

Conversely, in a case where the controller 101 determines that the PE compartment smoke detection condition is not satisfied but the battery compartment smoke detection condition is satisfied on the basis of the temperature of the PE compartment 2 detected by the PE compartment temperature sensor 103 and the temperature of the battery compartment 3 detected by the battery compartment temperature sensor 104, the controller 101 performs control for the battery compartment fire detection mode described in FIG. 11. In other words, the control valve 132 is controlled in the second mode, and the exhaust valve 130 is controlled in the first mode.

In a case where fire in the battery compartment 3 is detected from an electrical signal of the smoke detector 140 in the battery compartment fire detection mode (case \textcircled{4} in FIG. 15), the controller 101 performs control for the battery compartment fire extinguishing mode described in FIG. 13. In other words, the control valve 132 is controlled in the fourth mode, and the exhaust valve 130 is controlled in the second mode.

In addition, in a case where the controller 101 determines that both the PE compartment smoke detection condition and the battery compartment smoke detection condition are satisfied on the basis of the temperature of the PE compartment 2 detected by the PE compartment temperature sensor 103 and the temperature of the battery compartment 3 detected by the battery compartment temperature sensor 104 (case \textcircled{5} in FIG. 15), the controller 101 preferentially performs the control for the battery compartment fire detection mode described in FIG. 11. The control valve 132 is controlled in the second mode, and the exhaust valve 130 is controlled in the first mode.

While the control of the battery compartment fire detection mode is preferentially performed by the controller 101 as described above, in a case where fire occurring in the battery compartment 3 is detected from an electrical signal of the smoke detector 140 (case \textcircled{4} or \textcircled{6} in FIG. 15), the controller 101 performs the control for the battery compartment fire extinguishing mode described in FIG. 13. The control valve 132 is controlled in the fourth mode, and the exhaust valve 130 is controlled in the second mode.

However, in a case where fire is not detected in the battery compartment 3 within a third reference time after entering the battery compartment fire detection mode, the controller 101 performs the control for the PE compartment fire detection mode, and in a case where fire occurring in the PE compartment 2 is detected from the electrical signal of the smoke detector 140 during the PE compartment fire detection mode, the controller 101 performs the control for the PE compartment fire extinguishing mode described in FIG. 10 (same as case \textcircled{2} in FIG. 15). The control valve 132 is controlled in the third mode, and the exhaust valve 130 is controlled in the second mode.

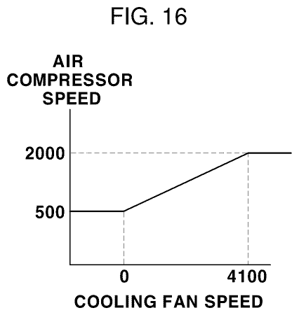

FIG. 16 is a diagram illustrating a method for determining a speed of the air compressor by the controller of the fire extinguishing system according to an embodiment of the present disclosure, and particularly, is a method for determining the speed of the air compressor 128 for the fire detection mode. In the present embodiment, in the fire extinguishing mode rather than the fire detection mode, the air compressor 12 may be controlled to operate at maximum speed.

As described above, in a case where it is determined that the PE compartment smoke detection condition is satisfied from the signal of the PE compartment temperature sensor 103, the controller 101 executes the PE compartment fire detection mode and operates the air compressor 128 in the fire detection mode. The speed (RPM) of the air compressor 128 is determined from the speed (RPM) of the cooling fan (electric fan) in the PE compartment 2.

In other words, in the PE compartment fire detection mode, the speed of the air compressor 128 is controlled to vary on the basis of the speed of the cooling fan in the PE compartment 2. The controller 101 determines the speed of the air compressor 128 corresponding to the speed of the cooling fan from setting data such as a map, and then, controls the speed of the air compressor 128 at the determined speed.

To this end, setting data that defines a correlation between the speed of the cooling fan and the speed of the air compressor may be preset in the controller.

In the setting data, the speed of the air compressor corresponding to the speed of the cooling fan is preset, and the speed (target speed) of the air compressor in the setting data may be set to a larger value as the speed of the cooling fan becomes larger.

Similarly, in a case where the controller 101 determines that the battery compartment smoke detection condition is satisfied on the basis of a signal from the battery compartment temperature sensor 104, the controller 101 executes the battery compartment fire detection mode and operates the air compressor 128 in the fire detection mode. The speed of the air compressor 128 is determined from the speed (RPM) of the cooling fan (electric fan, reference numeral 9 in FIG. 4) in the battery compartment.

In other words, in the battery compartment fire detection mode, the speed (RPM) of the air compressor 128 is controlled to vary on the basis of the speed (RPM) of the cooling fan 9 in the battery compartment 3. The controller 101 determines the speed of the air compressor 128 corresponding to the speed of the cooling fan 9 from setting data such as a map as in FIG. 16, and then, controls the speed of the air compressor 128 at the determined speed.

The setting data for determining the speed of the air compressor from the speed of the cooling fan in the battery compartment in the battery compartment fire detection mode may be the same as the setting data for determining the speed of the air compressor from the speed of the cooling fan in the PE compartment in the PE compartment fire detection mode.

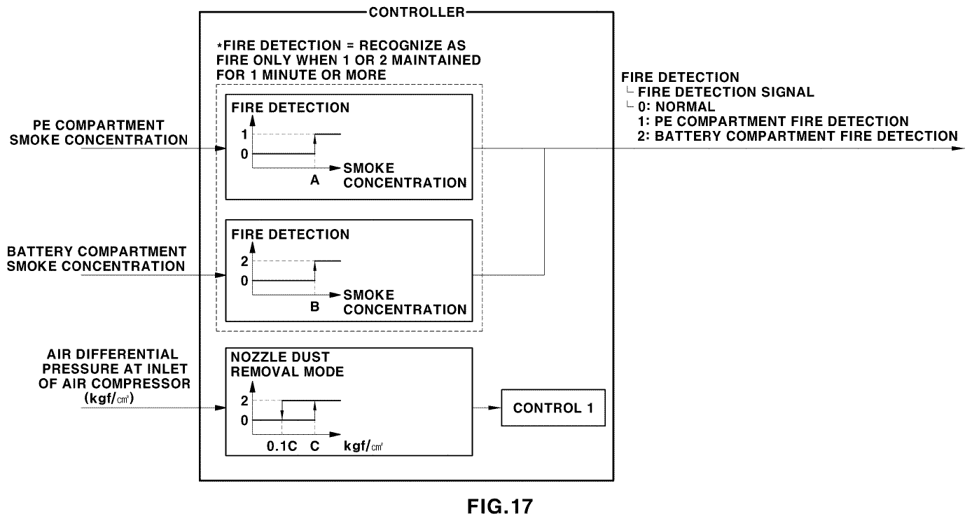

FIG. 17 is a diagram illustrating a method for detecting fire by the controller of the fire extinguishing system according to an embodiment of the present disclosure. In the fire detection mode shown in FIGS. 10 and 11, in a case where it is determined that fire occurs from an electrical signal of the smoke detector 140, the controller 101 generates a fire detection signal according to the determination result.

The electrical signal output by the smoke detector 140 is a signal corresponding to the concentration of smoke in air suctioned through the smoke detection pipe 133 from the PE compartment 2 and the battery compartment 3. The controller 101 determines a PE compartment smoke concentration from the electrical signal output by the smoke detector 140 in the PE compartment fire detection mode, and determines a battery compartment smoke concentration from the electrical signal output by the smoke detector 140 in the battery compartment fire detection mode.

In addition, the controller 101 compares the determined PE compartment smoke concentration or battery compartment smoke concentration with a preset reference value A or B, and in a case where the PE compartment smoke concentration or battery compartment smoke concentration remains equal to or greater than the reference value for a preset time, it is determined that fire occurs in the corresponding space.

According to an embodiment, referring to FIG. 17, in the PE compartment fire detection mode, in a case where the PE compartment smoke concentration is equal to or greater than the value A or greater, which is the reference value, for a preset time (e.g., 1 minute), the controller 101 determines that there occurs fire in the PE compartment 2, and generates a fire detection signal (signal value “1”) indicating fire occurrence in the PE compartment 2.

In a case where the smoke concentration in the battery compartment is equal to or greater than the reference value B for the set time in the battery compartment fire detection mode, the controller 101 determines that there occurs fire in the battery compartment 3, and generates a fire detection signal (signal value “2”) indicating fire occurrence in the battery compartment 3. In a normal state where no fire occurs, the controller 101 may generate a signal (signal value “0”) indicating the normal state.

In addition, a pressure sensor (not shown) that detects an air differential pressure at the intake port (suction side) is provided in the air compressor 128 as normal, and the pressure sensor is connected to enable signal input to the controller 101.

An electrical signal output by the pressure sensor is a signal corresponding to an air pressure (air differential pressure) applied to the inlet of the air compressor 128, and the electrical signal output by the pressure sensor is transmitted to the controller 101.

In the present embodiment, the controller 101 may periodically perform a nozzle dust removal mode using the detection result of the pressure sensor. In the nozzle dust removal mode, the controller 101 operates the air compressor 128 to apply suction pressure to each fire response space, and determines whether a predetermined level or higher of dust has accumulated in the nozzle 110 of the smoke suctioning and fire extinguishing fluid discharge pipe 102a or 102b provided in each fire response space.

The controller 101 determines the air differential pressure, which is the pressure at the inlet port of the air compressor 128, on the basis of the electrical signal input from the pressure sensor while the air compressor 128 is operating. In a case where the air differential pressure detected by the pressure sensor is equal to or higher than a first set pressure (an upper threshold “C”), the controller 101 determines that the predetermined level of dust has accumulated in the nozzle 110 of the smoke suctioning and fire extinguishing fluid discharge pipe 102a or 102b provided in each fire response space.

In a case where it is determined that the predetermined level of dust has accumulated, the controller 101 performs control for nozzle reverse cleaning (“control 1” of FIG. 17), operates the air compressor 128 in the reverse direction at a set speed (e.g., 3,000 RPM), and controls the opening states of the control valve 132 and the exhaust valve 130 in the same manner as in the PE compartment fire detection mode and the battery compartment fire detection mode.

In an embodiment of the present disclosure, a nozzle reverse cleaning process of the smoke suctioning and fire extinguishing fluid discharge pipe 102a in the PE compartment 2 and a nozzle reverse cleaning process of the smoke suctioning and fire extinguishing fluid discharge pipe 102b in the battery compartment 3 may be performed in a preset order and for a preset time.

As a result, the high-pressure compressed air discharged in the reverse direction from the intake port of the air compressor 128 moves in the reverse direction with respect to the fire direction and is supplied to the PE compartment-side smoke suctioning and fire extinguishing fluid discharge pipe 102a or the battery compartment-side smoke suctioning and fire extinguishing fluid discharge pipe 102b.

Thus, the high-pressure compressed air is discharged through each nozzle 110 from the smoke suctioning and fire extinguishing fluid discharge pipe 102a or 102b in each fire response space of the PE compartment 2 and the battery compartment 3, to thereby perform the reverse cleaning for removing the dust accumulated in each nozzle.

During the reverse cleaning, the operation of the air compressor 128 is maintained until the air differential pressure at the inlet of the air compressor detected by the pressure sensor reaches a second set pressure (a lower threshold “0.1 C”), and in a case where the air differential pressure reaches the second set pressure, the operation of the air compressor 128 is stopped.

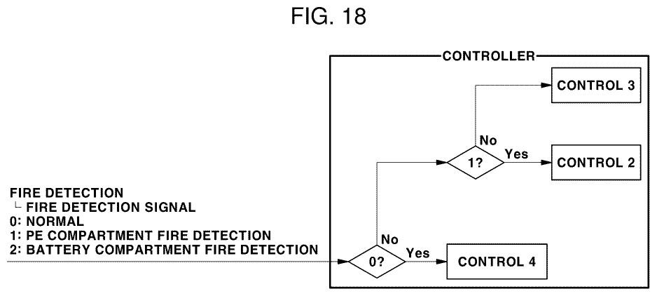

FIG. 18 is a diagram illustrating a control state in fire detection of the fire extinguishing system according to an embodiment of the present disclosure.

In a case where it is determined that fire occurs in the PE compartment 2, i.e., in a case where the controller 101 generates a fire detection signal with a signal value of “1”, the controller 101 controls the opening states of the exhaust valve 130 and the second control valve 132 as shown in FIG. 12, and operates the air compressor 128 (“control 2” in FIG. 18). The air compressor 128 may be operated at the maximum speed.

This allows the fire extinguishing fluid charged in the fire extinguishing fluid tank 121 to be supplied to the PE compartment-side smoke suctioning and fire extinguishing fluid discharge pipe 102a, and thus, allows the fire extinguishing fluid to be sprayed into the PE compartment 2 through each nozzle 110 from the PE compartment-side smoke suctioning and fire extinguishing fluid discharge pipe 102a, thereby extinguishing the fire in the PE compartment.

Further, in a case where the controller 101 generates the fire detection signal “1”, the controller 101 operates a warning device (not shown) of the vehicle 1 according to the fire detection signal to notify a driver of the fire occurrence and the status of fire extinguishing fluid spraying in the PE compartment 2, and also wirelessly transmits a fire occurrence signal to a nearby fire station for dispatch of a fire truck.

In a case where the controller 101 determines that fire occurs in the battery compartment 3, i.e., in a case where the controller 101 generates a fire detection signal with a signal value of “2”, as shown in FIG. 13, the controller 101 controls the opening states of the exhaust valve 130 and the control valve 132, and operates the air compressor 128 (“control 3” in FIG. 18). The air compressor 128 may be operated at the maximum speed.

This allows the fire extinguishing fluid charged in the fire extinguishing fluid tank 121 to be supplied to the battery compartment-side smoke suctioning and fire extinguishing fluid discharge pipe 102b, and thus, allows the fire extinguishing fluid to be sprayed into the battery compartment 3 through each nozzle 110 from the battery compartment-side smoke suctioning and fire extinguishing fluid discharge pipe 102b, thereby extinguishing the fire in the battery compartment.

Further, in a case where the controller 101 generates the fire detection signal “2”, the controller 101 operates the warning device of the vehicle 1 according to the fire detection signal to notify the driver of the fire occurrence and the status of fire extinguishing fluid spraying in the battery compartment 3, and also wirelessly transmits a fire occurrence signal to a nearby fire station for dispatch of a fire truck.

In a case where the PE compartment 2 or the battery compartment 3 is in the normal state where no fire occurs, the controller 101 may maintain the air compressor 128 in an off state (“control 4” in FIG. 18). The control valve 132 and the exhaust valve 130 may be maintained in the state of FIG. 10 or FIG. 11.

According to the fire extinguishing system for the vehicle according to an embodiment of the present disclosure, it is possible to accurately detect fire occurring in a vehicle, and quickly and automatically extinguish the fire.

The disclosure has been described in detail with reference to preferred embodiments thereof. However, it should be appreciated by those having ordinary skill in the art that changes may be made in these embodiments without departing from the principles and spirit of the disclosure, the scope of which is defined in the appended claims and their equivalents.

What is claimed is:

1. A fire extinguishing system for a vehicle, the system comprising:
a smoke suctioning and fire extinguishing fluid discharge pipe provided in each of a plurality of fire response spaces and including a nozzle configured to spray a fire extinguishing fluid;
a smoke detection pipe connected to the smoke suctioning and fire extinguishing fluid discharge pipe through a control valve to selectively communicate with the smoke suctioning and fire extinguishing fluid discharge pipe;
an air compressor configured to apply suction pressure to the smoke detection pipe;
a smoke detector configured to detect smoke suctioned through the nozzle and the smoke suctioning and fire extinguishing fluid discharge pipe;
a controller configured to output, based on the smoke detected by the smoke detector after entering a fire detection mode in a fire response space selected from the plurality of fire response spaces, a control signal for spraying the fire extinguishing fluid to the fire response space where the smoke is detected; and
a fire extinguishing fluid supply device configured to supply, based on the control signal output from the controller, the fire extinguishing fluid to the smoke suctioning and fire extinguishing fluid discharge pipe in the fire response space where the smoke is detected through a fire extinguishing fluid supply pipe.

2. The system according to claim 1, wherein the plurality of fire response spaces includes at least one of a power electric (PE) compartment in which power electric PE parts are provided or a battery compartment in which a battery is provided.

3. The system according to claim 1, wherein the control valve is configured to control a flowing direction of the fire extinguishing fluid in the fire extinguishing fluid supply pipe so that the fire extinguishing fluid supplied from the fire extinguishing fluid supply device based on the control signal output by the controller is supplied to the fire response space where the smoke is detected.

4. The system according to claim 1, wherein:
the fire extinguishing fluid supply pipe extended from the fire extinguishing fluid supply device is branched to each of the plurality of fire response spaces and connected to the smoke suctioning and fire extinguishing fluid discharge pipe in each of the plurality of fire response spaces;
the control valve is provided at a location where the fire extinguishing fluid supply pipe is branched;
the smoke detection pipe is connected to the control valve; and
the smoke detection pipe is configured to selectively communicate with the smoke suctioning and fire extinguishing fluid discharge pipe in each of the plurality of fire response spaces through the fire extinguishing fluid supply pipe branched to each of the plurality of fire response spaces based on an opening state of the control valve.

5. The system according to claim 4, wherein the controller is further configured to:
operate the air compressor in the fire detection mode; and
control the opening state of the control valve so that the fire extinguishing fluid supply pipe branched to the fire response space in the fire detection mode and the smoke detection pipe communicate with each other to apply suction pressure generated by the air compressor to the fire response space in the fire detection mode.

6. The system according to claim 4, wherein the plurality of fire response spaces comprises:
a power electric (PE) compartment in which PE parts are provided; and
a battery compartment in which a battery is provided,
wherein the control valve is a 4-way valve provided between
the fire extinguishing fluid supply pipe connected to the fire extinguishing fluid supply device,
the fire extinguishing fluid supply pipe branched to the PE compartment,
the fire extinguishing fluid supply pipe branched to the battery compartment, and
the smoke detection pipe.

7. The system according to claim 1, further comprises:
a temperature sensor provided in each of the plurality of fire response spaces,
wherein the controller is further configured to:
determine whether a smoke detection condition of each of the plurality of fire response spaces is satisfied based on a temperature detected by the temperature sensor, and
execute the fire detection mode in the fire response space in which the smoke detection condition is determined to be satisfied.

8. The system according to claim 7, wherein a plurality of temperature sensors is provided in each of the plurality of fire response spaces, and
wherein the controller is further configured to:
determine, based on that a maximum value of change values of temperatures detected by the plurality of temperature sensors provided in each of the plurality of fire response spaces for a predetermined time is equal to or greater than a predetermined change value, or a maximum value of the temperatures detected by the plurality of temperature sensors is equal to or greater than a predetermined temperature, that a fire detection condition in a corresponding fire response space is satisfied; and
execute the fire detection mode for the corresponding fire response space.

9. The system according to claim 7, wherein the plurality of fire response spaces comprises:
a power electric (PE) compartment in which PE parts are provided; and
a battery compartment in which a battery is provided, and
wherein the controller is further configured to execute the fire detection mode for the battery compartment, based on determining that the smoke detection condition of the PE compartment and the battery compartment are simultaneously satisfied and the temperatures detected by the temperature sensor provided in the PE compartment and the temperature sensor provided in the battery compartment.

10. The system according to claim 9, wherein the controller is further configured to execute the fire detection mode for the PE compartment, based on that the smoke detection conditions of the PE compartment and the battery compartment are simultaneously satisfied, and smoke in the battery compartment is not detected for a predetermined time by the smoke detector in the fire detection mode for the battery compartment.

11. The system according to claim 7, wherein the controller is further configured to:
operate the air compressor in the fire detection mode; and
control an opening state of the control valve so that the smoke suctioning and fire extinguishing fluid discharge pipe provided in the fire response space in which the smoke detection condition is satisfied and the smoke detection pipe communicate with each other to apply suction pressure by the air compressor to the fire response space in which the smoke detection condition is satisfied.

12. The system according to claim 1, wherein, in applying the suction pressure of the air compressor to the smoke suctioning and fire extinguishing fluid discharge pipe provided in the fire response space through the smoke detection pipe, the controller is further configured to:
determine a target speed based on a speed of a cooling fan provided in the fire response space; and
control an operation of the air compressor at the determined target speed.

13. The system according to claim 12, wherein the speed of the air compressor increases as the speed of the cooling fan installed in the fire response space increases.

14. The system according to claim 1, wherein the fire extinguishing fluid supply device comprises:
a fire extinguishing fluid tank in which the fire extinguishing fluid is stored; and
a pressure transfer plate configured to be moved by pressure of a working fluid supplied to a pressure chamber of the fire extinguishing fluid tank and pressurize the fire extinguishing fluid charged in the fire extinguishing fluid chamber of the fire extinguishing fluid tank to discharge the fire extinguishing fluid from the fire extinguishing fluid tank to the fire extinguishing fluid supply pipe.

15. The system according to claim 14, wherein the working fluid is compressed air supplied by the air compressor.

16. A fire extinguishing system for a vehicle, the system comprising:
a smoke suctioning and fire extinguishing fluid discharge pipe provided in each of a plurality of fire response spaces and including a nozzle configured to spray a fire extinguishing fluid;
a smoke detection pipe connected to the smoke suctioning and fire extinguishing fluid discharge pipe through a control valve to selectively communicate with the smoke suctioning and fire extinguishing fluid discharge pipe;
an air compressor configured to apply suction pressure to the smoke detection pipe;
a smoke detector configured to detect smoke suctioned through the nozzle and the smoke suctioning and fire extinguishing fluid discharge pipe, wherein the smoke is drawn in by the suction pressure of the air compressor acting on the smoke suctioning and fire extinguishing fluid discharge pipe through the smoke detection pipe; and
a controller configured to:
receive an input from the smoke detector,
output, based on the smoke detected by the smoke detector after entering a fire detection mode in a fire response space selected among the plurality of fire response spaces, a control signal for spraying the fire extinguishing fluid to the fire response space where the smoke is detected, and
cause a fire extinguishing fluid supply device to supply the fire extinguishing fluid to the smoke suctioning and fire extinguishing fluid discharge pipe in the fire response space where the smoke is detected through a fire extinguishing fluid supply pipe.

17. The system according to claim 16, wherein the plurality of fire response spaces includes at least one of a power electric (PE) compartment in which PE parts are provided or a battery compartment in which a battery is provided.

18. The system according to claim 16, wherein the control valve is configured to control a flowing direction of the fire extinguishing fluid in the fire extinguishing fluid supply pipe so that the fire extinguishing fluid supplied from the fire extinguishing fluid supply device based on the control signal output by the controller is supplied to the fire response space where the smoke is detected.

19. The system according to claim 16, wherein:
the fire extinguishing fluid supply pipe extended from the fire extinguishing fluid supply device is branched to each of the plurality of fire response spaces and connected to the smoke suctioning and fire extinguishing fluid discharge pipe in each of the plurality of fire response spaces;
the control valve is provided at a location where the fire extinguishing fluid supply pipe is branched;
the smoke detection pipe is connected to the control valve; and
the smoke detection pipe is configured to selectively communicate with the smoke suctioning and fire extinguishing fluid discharge pipe in each of the plurality of fire response spaces through the fire extinguishing fluid supply pipe branched to each of the plurality of fire response spaces based on an opening state of the control valve.

20. The system according to claim 19, wherein the controller is further configured to:
operate the air compressor in the fire detection mode; and
control the opening state of the control valve so that the fire extinguishing fluid supply pipe branched to the fire response space in the fire detection mode and the smoke detection pipe communicate with each other to apply suction pressure generated by the air compressor to the fire response space in the fire detection mode.
